(19) United States
(12) Patent Application Publication
(10) Pub. No.: US 2011/0117785 A1
(43) Pub. Date: May 19, 2011

(54) LED ILLUMINATION APPARATUS

(75) Inventor: Taketo TAKATA, Toyama (JP)

(73) Assignee: SMK CORPORATION, Tokyo (JP)

(21) Appl. No.: 12/815,244

(22) Filed: Jun. 14, 2010

(30) Foreign Application Priority Data
Nov. 13, 2009 (JP) 2009-259493
Feb. 11, 2010 (JP) 2010-028309

(51) Int. Cl. H01R 31/06

(52) U.S. Cl. 439/628

(57) ABSTRACT

Parts exchange or the like is not easy with an LED illumination apparatus that uses an LED attached to a socket of a conventional fluorescent light fixture. Other problems also exist such as unfavorable operability and reliability, and necessitating additional parts. Provided herewith is an LED illumination apparatus including a cap having a terminal electrically coupled to a socket of a fluorescent light fixture and a main body having an end coupled with the cap, where the main body includes an LED and a coupler to electrically couple the terminal to the LED, the terminal being fitted in the coupler.

### BACKGROUND

1. TECHNICAL FIELD

The present invention relates to an LED illumination apparatus that uses an LED (light emitting diode) attached to a socket of a fluorescent light fixture. The contents of the following patent application is incorporated herein by reference, NO. 2009-259493 filed on Nov. 13, 2009, and NO. 2010-028309 filed on Feb. 11, 2010.

2. RELATED ART

LED illumination apparatuses that use a white LED with high luminance, energy saving capability, and long life have already been developed to replace conventional illumination apparatuses such as fluorescent lamps.

Patent Document No. 1: Japanese Patent Application Publication No. 2001-351402

Patent Document No. 2: Japanese Patent No. 4156657

Patent Document No. 3: Japanese Utility Model Registration No. 3148176

Patent Document No. 1 proposes an LED illumination apparatus that can be attached to an already-installed fluorescent light fixture with ease.

Patent Document No. 2 proposes an LED illumination apparatus that is assembled efficiently.

FIG. 11 shows an internal structure of a conventional LED illumination apparatus. The LED illumination apparatus includes a main body 1, a cap 3, a print substrate 4, a plurality of LEDs 5, and an electric wire 7, where the cap 3 holds a pair of pin terminals 2 attachable to an already-installed fluorescent light fixture and is joined to the main body 1, the print substrate 4 is accommodated in the main body 1 and has an electric control circuitry mounted thereon, the plurality of LEDs 5 are mounted to the print substrate 4, the electric wire 7 has one end connected to the print substrate 4 and the other end connected to the pair of pin terminals 2, and the pair of pin terminals 2 and the electric terminal 7 are connected to each other by swaging or soldering. The connection by waging or soldering is not only difficult to work with, but also the electric wire, once connected, is structurally difficult to be removed, and the parts exchange is difficult to pursue.

Patent Document No. 3 proposes an LED illumination apparatus having an LED illumination section and/or the LED itself exchangeable. The structure of bringing the contacts into contact with each other has a possibility of causing outage and contact failure, which is not favorable as an illumination apparatus.

Wiring in some fluorescent light fixtures is such that only one pole of the pair of electrodes of the socket 8 is connected to the power source, as shown in FIG. 12. Therefore, both of the pin terminals 2 should be connected to the print substrate 4. One method to realize this is to connect both of the pin terminals 2 to the print substrate 4 via two electric wires, as shown in FIG. 11. Another method is to connect a round terminal 9a to one end of the electric wire 7 drawn from the print substrate 4, to be connected to a pin terminal 2 using screw, as shown in FIGS. 13A and 13B. Note that the round terminal 9a and a round terminal 9b that is different from the round terminal 9a are short circuited therebetween using a jumper line 10, and the round terminal 9b is connected to another pin terminal 2 using screw.

### SUMMARY

In this way, with a conventional method, parts exchange and the like are difficult. Other problems also exist such as unfavorable operability and reliability, and necessitating additional parts.

So as to solve the above-stated problems, according to a first aspect of the innovations herein, provided is an LED illumination apparatus including: a cap having a terminal electrically coupled to a socket of a fluorescent light fixture; and a main body having an end coupled with the cap, where the main body includes: an LED; and a coupler to electrically couple the terminal to the LED, the terminal being fitted in the coupler.

In the above-stated LED illumination apparatus, the coupler may be removably coupled with the terminal. In the above-stated LED illumination apparatus, the coupler may include a lock section removably coupled with a groove formed on the terminal. The above-stated LED illumination apparatus may have such a structure that the lock section has flexibility or elasticity, and by means of the flexibility or the elasticity, the lock section removably couples the terminal to the coupler.

In the above-stated LED illumination apparatus, the coupler may be removably coupled with the cap. In the above-stated LED illumination apparatus, the coupler may include a lock section removably coupled with a lock engaging section formed on the cap. The above-stated LED illumination apparatus may have such a structure that the lock section has flexibility or elasticity, and by means of the flexibility or the elasticity, the lock section removably couples the cap to the coupler.

In the above-stated LED illumination apparatus, the cap may include a holding section to hold the coupler. In the above-stated LED illumination apparatus, the terminal may be electrically insulated from the cap. The above-stated LED illumination apparatus may have such a structure that the terminal is a pair of pin terminals, and the coupler is electrically coupled with both of the pair of pin terminals. In the above-stated LED illumination apparatus, the coupler may be an integrally formed metal plate.

In the above-stated LED illumination apparatus, the main body may further include an electric wire to electrically couple the coupler with the LED. The above-stated LED illumination apparatus may have such a structure that the main body further includes a print substrate provided with the LED and an electric control circuitry, and the electric wire has an end connected to the coupler and the other end connected to the print substrate.

The above structure allows to exchange the parts such as an LED illuminating section and/or the LED itself with ease.

### BRIEF DESCRIPTION OF THE DRAWINGS

FIG. 1 is an exploded view of an LED illumination apparatus according to the present invention (Embodiment Example 1).

FIG. 2 is a sectional view of the LED illumination apparatus according to the present invention (Embodiment Example 1).

FIG. 3 is a sectional view of a cap 3 according to Embodiment Example 1.

FIG. 4 is an internal perspective view of the cap 3 according to Embodiment Example 1.

FIG. 5 is a perspective view of a connecting terminal 6 according to Embodiment Example 1.

FIG. 6 shows the state in which the cap 3 is assembled with the connecting terminal 6 according to Embodiment Example 1.

FIG. 7 shows a sectional view of the state in which the cap 3 is assembled with the connecting terminal 6 according to Embodiment Example 1.

FIG. 8 is a perspective view of a cap 3 and a connecting terminal 6 according to Embodiment Example 2.

FIG. 9 is a perspective view of a cap 3 and a connecting terminal 6 according to Embodiment Example 3.

FIG. 10 is an enlarged view of a lock section 6d according to Embodiment Example 3.

FIG. 11 is an exploded sectional view of a conventional LED illumination apparatus.

FIG. 12 is a wiring diagram of a fluorescent light fixture.

FIGS. 13A and 13B are a connection diagram for a conventional LED illumination apparatus.

### DESCRIPTION OF EXEMPLARY EMBODIMENTS

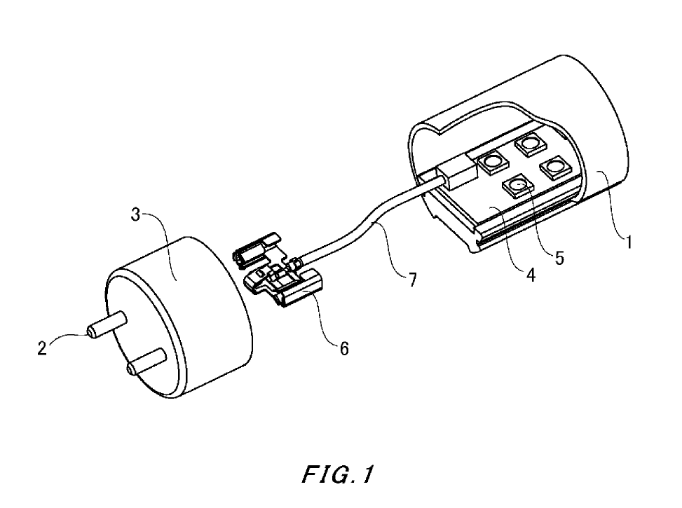

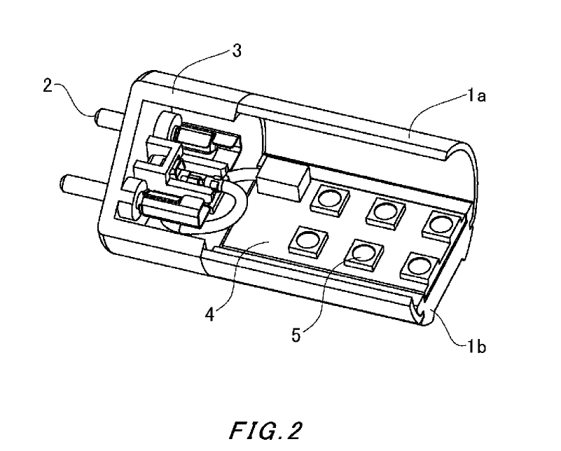

As shown in FIG. 1 and FIG. 2, an LED illumination apparatus according to the present embodiment holds a main body 1, a cap 3, a print substrate 4, an LED 5, a connecting terminal 6, and an electric wire 7, where the cap 3 holds a pair of pin terminals 2 fitted to a socket 8 of a fluorescent light fixture and is joined to the main body 1, the print substrate 4 is accommodated in the main body 1 and has an electric control circuitry mounted thereon, the LED 5 is mounted to the print substrate 4, the connecting terminal 6 is for connection with the pair of pin terminals 2, and the electric wire 7 has one end connected to the print substrate 4 and the other end connected to the connecting terminal 6.

The pair of pin terminals 2 are electrically coupled to the socket 8 of the fluorescent light fixture. The connecting terminal 6 electrically couples the pair of pin terminals 2 and the LED 5. The pair of pin terminals 2 are fitted into the connecting terminal 6. The connecting terminal 6 is removably coupled to the pair of pin terminals 2. The connecting terminal 6 may be an integrally formed metal plate. The pair of pin terminals 2 may be an example of a terminal connected to a socket of a fluorescent light fixture. The connecting terminal 6 may be an example of a coupler.

In the present embodiment, the pair of pin terminals 2 are provided through a cap. However, the pair of pin terminals 2 are not limited to this structure. The pair of pin terminals 2 may include a member fitted to a socket, and a member connected to the connecting terminal 6, so that both of the member fitted to a socket and the member connected to the connecting terminal 6 be electrically coupled to each other.

The term “electrically coupled” or the derivatives thereof may refer to a case where the corresponding members are in contact with each other, and not limited to a case in which the members are electrically connected to each other. The term “electrically coupled” or the derivatives thereof may also include a case where the members form a part of the electric path.

### Embodiment Example 1

The main body 1 is a combination between an optical diffusion section 1a made of a transparent or semi-transparent resin (e.g. polycarbonate resin) and a heat dissipating section 1b made of an aluminum alloy or the like, and has a cylindrical form. However, the heat dissipating section 1b may be created as a heat sink having convex and concave portions. Note that the main body 1 is not limited to the described combination, and may be made of only a resin.

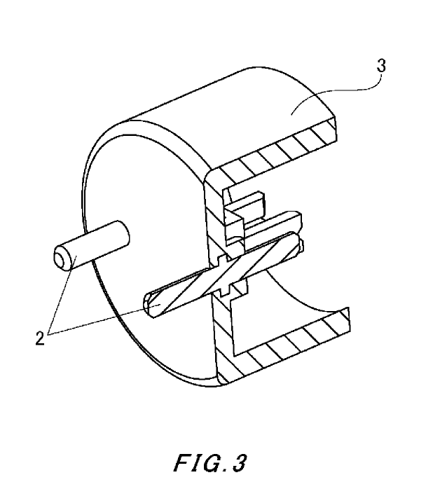

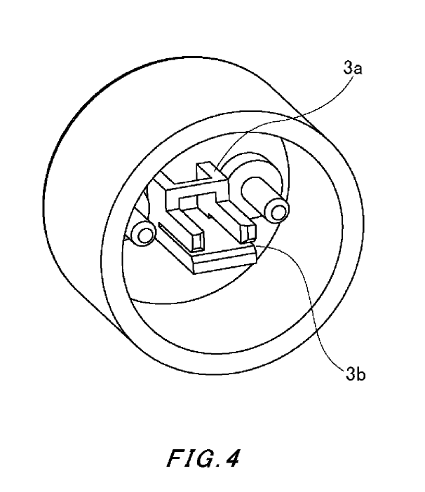

The cap 3 having a pair of pin terminals 2 made of a copper alloy sized to suit to an already installed fluorescent light fixture is joined to each end of the main body 1, and has a structure removable from the main body 1 for internal maintenance. Although FIG. 3 shows a cap 3 integrally formed with a pair of pin terminals 2 using an insulation resin, the pair of pin terminals 2 may be attached to the cap 3 by press fit or swaging. In addition, as shown in FIG. 4, a groove 3b for assembling the connecting terminal 6 and a lock engaging section 3a for engaging the lock section 6c of the connecting terminal 6 are formed within the cap 3. Note that the material of the cap 3 may be metal, not limited to an insulation resin, as long as the pin terminal 2 and the cap 3 are electrically insulated from each other for avoiding electric shock. The groove 3b holds the connecting terminal 6. The groove 3b may be an example of a holding section.

An electric control circuitry for rectification and voltage control (not shown in the drawings) and a plurality of LEDs 5 are mounted to the print substrate 4, and the electric wire 7 to which the connecting terminal 6 is attached is drawn from an end of the print substrate 4. The print substrate 4 is accommodated in the main body 1. The LEDs 5 in this example are surface-mounting white LEDs, but may be shell-type LEDs. The number of LEDs 5 is defined according to the specification of illumination.

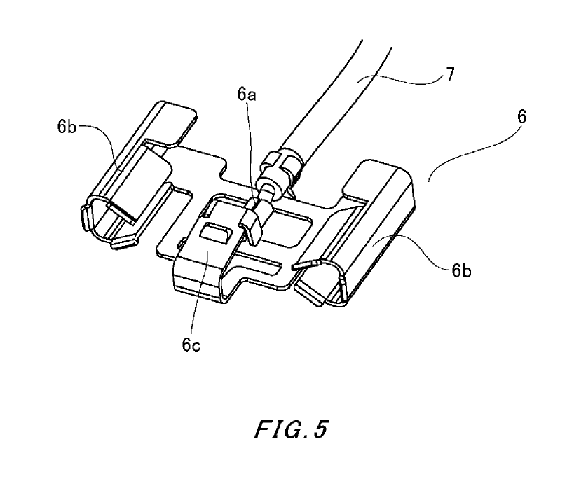

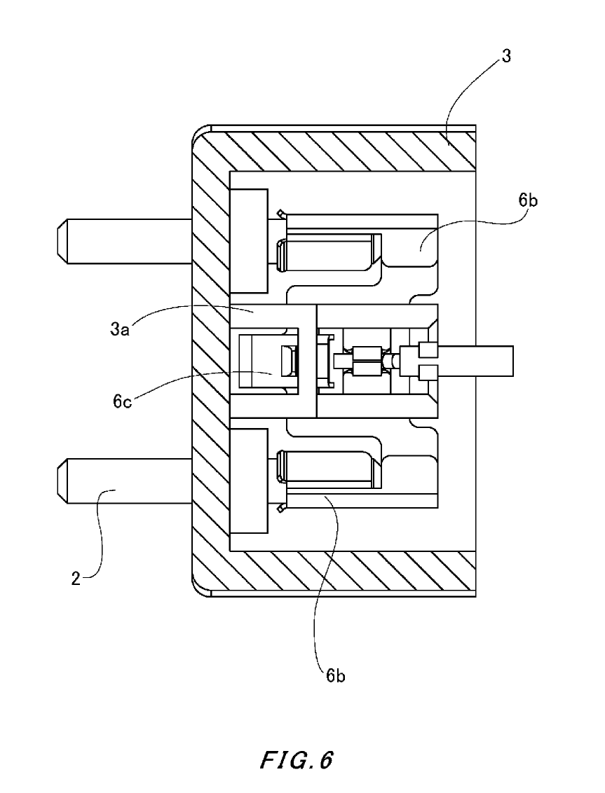

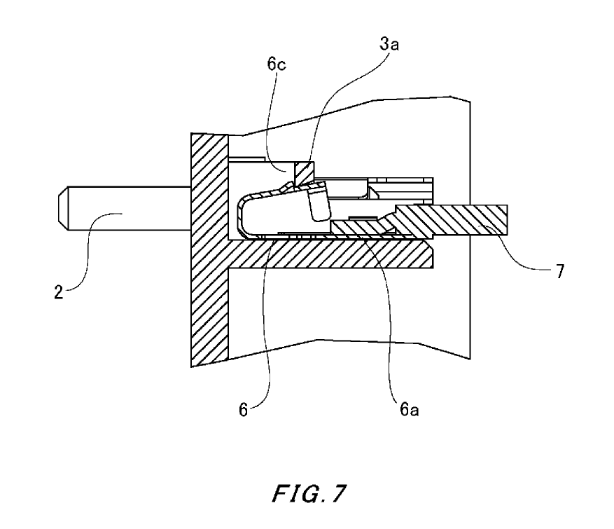

The connecting terminal 6 is fabricated by press working a copper alloy, and is configured by a crimp section 6a, pin terminal connecting sections 6b, and a lock section 6c as shown in FIG. 5. The electric wire 7 is connected to the crimp section 6a. There are two pin terminal connecting sections 6b, to allow connection by inserting the pair of pin terminals 2 therethrough. As shown in FIG. 6 and FIG. 7, the lock section 6c has a U-shaped sectional form, and an end thereof is bent to be engaged with the lock engaging section 3a of the cap 3, to hold the connecting terminal 6. Note that the elasticity of the lock section 6c facilitates removal of the connecting terminal 6 from the cap 3 using a simple tool to cancel the lock. Moreover, by introducing the connecting terminal 6 into the groove 3b of the cap 3, the shock from the electric wire 7 is prevented. The above structure allows to exchange the parts such as an LED illuminating section and/or the LED itself with ease. The pin terminals 2 can be connected to the print substrate 4 with ease using only a single electric wire 7 and the connecting terminal 6.

### Embodiment Example 2

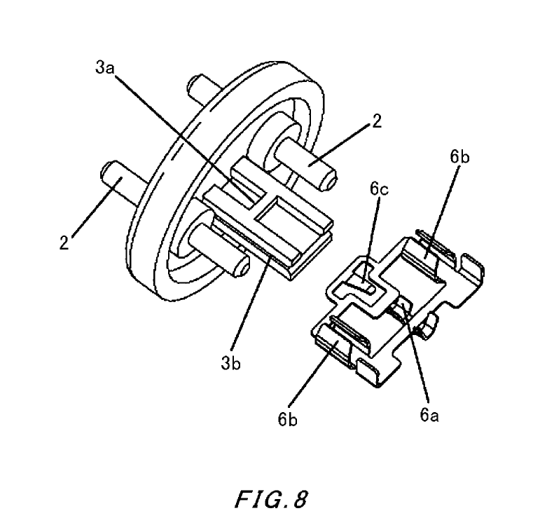

FIG. 8 shows a cap 3 and a connecting terminal 6 according to Embodiment Example 2. The only difference of the lock section 6c in Embodiment Example 2 from its counterpart in Embodiment Example 1 is that the lock section 6c in Embodiment Example 2 has a tongue-like shape. The lock section 6c is bent to be engaged with the lock engaging section 3a of the cap 3, thereby holding the connecting terminal 6. Note that the elasticity of the lock section 6c facilitates removal of the connecting terminal 6 from the cap 3 using a simple tool to cancel the lock. This also allows the cap 3 to hold the connecting terminal 6 with a simple structure, without using any additional parts.

### Embodiment Example 3

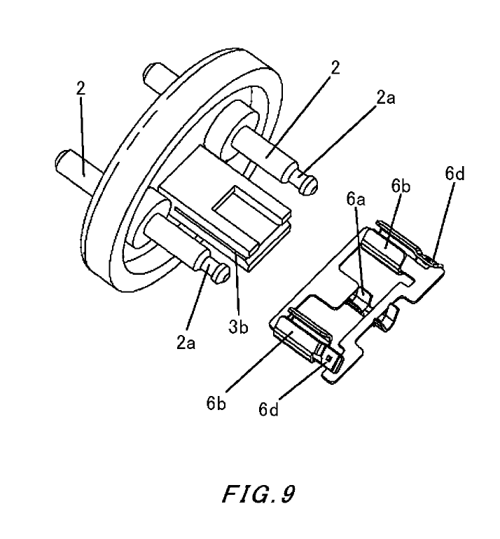

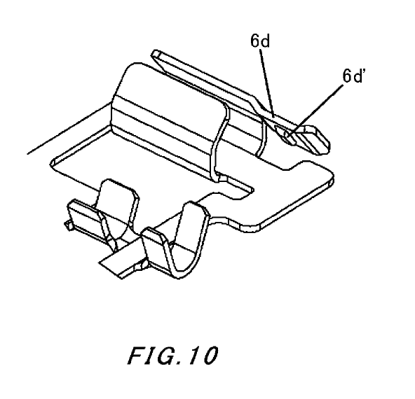

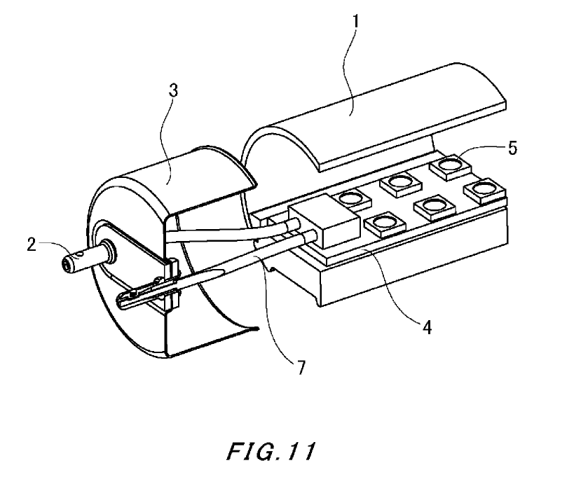

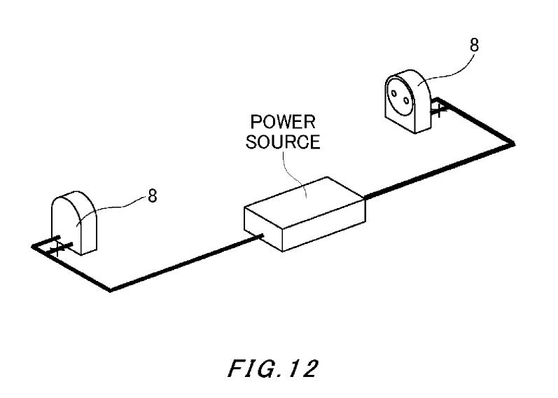

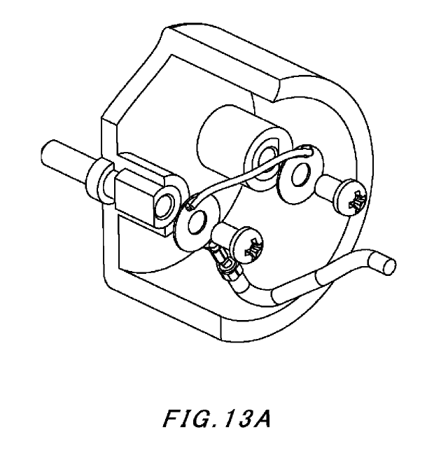

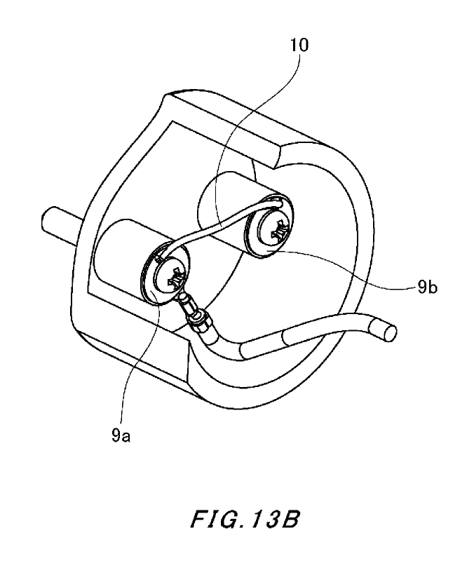

FIG. 9 shows a cap 3 and a connecting terminal 6 according to Embodiment Example 3. The following explains only the differences from Embodiment Example 1. Each pin terminals 2 according to Embodiment Example 3 is provided with a groove 2a. A lock section 6d is formed on the connecting terminal 6. The lock section 6d is provided in the vicinity of the pin terminal connecting section 6b, so as to be engaged with the groove 2a, and holds the connecting terminal 6 by being engaged with the groove 2a by means of the elasticity of the lock section 6d. As shown in FIG. 10, by being provided with a protrusion 6d′, the lock section 6d is assuredly engaged with the groove 2a. Note that the elasticity of the lock section 6d facilitates removal of the connecting terminal 6 from the cap 3 using a simple tool to cancel the lock. In this way, according to the configuration of Embodiment Example 3, the cap 3 is not necessarily provided with a lock engaging section 3a, unlike in the case of Embodiment Example 1, and so Embodiment Example 3 advantageously simplify the structure of a mold for shaping the cap 3.

The present invention is applicable to an LED illumination apparatus that uses an LED (light emitting diode) attached to a socket of a fluorescent light fixture.

What is claimed is:

1. An LED illumination apparatus comprising:
a cap having a terminal electrically coupled to a socket of a fluorescent light fixture; and
a main body having an end coupled with the cap, wherein
the main body includes:
an LED; and
a coupler to electrically couple the terminal to the LED, the terminal being fitted in the coupler.

2. The LED illumination apparatus according to claim 1, wherein
the coupler is removably coupled with the terminal.

3. The LED illumination apparatus according to claim 2, wherein
the coupler includes a lock section removably coupled with a groove formed on the terminal.

4. The LED illumination apparatus according to claim 3, wherein
the lock section has flexibility or elasticity, and
by means of the flexibility or the elasticity, the lock section removably couples the terminal to the coupler.

5. The LED illumination apparatus according to claim 1, wherein
the coupler is removably coupled with the cap.

6. The LED illumination apparatus according to claim 5, wherein
the coupler includes a lock section removably coupled with a lock engaging section formed on the cap.

7. The LED illumination apparatus according to claim 6, wherein
the lock section has flexibility or elasticity, and
by means of the flexibility or the elasticity, the lock section removably couples the cap to the coupler.

8. The LED illumination apparatus according to claim 1, wherein
the cap includes a holding section to hold the coupler.

9. The LED illumination apparatus according to claim 1, wherein
the terminal is electrically insulated from the cap.

10. The LED illumination apparatus according to claim 1, wherein
the terminal is a pair of pin terminals, and
the coupler is electrically coupled with both of the pair of pin terminals.

11. The LED illumination apparatus according to claim 1, wherein
the coupler is an integrally formed metal plate.

12. The LED illumination apparatus according to claim 1, wherein
the main body further includes an electric wire to electrically couple the coupler with the LED.

13. The LED illumination apparatus according to claim 12, wherein
the main body further includes a print substrate provided with the LED and an electric control circuitry, and
the electric wire has an end connected to the coupler and the other end connected to the print substrate.
